(19) United States
(12) Patent Application Publication
(10) Pub. No.: US 2015/0339224 A1
(43) Pub. Date: Nov. 26, 2015

(54) SYSTEM AND METHOD FOR HOST-PROCESSOR COMMUNICATION OVER A BUS

(71) Applicant: ICELERO INC., San Jose, CA (US)

(72) Inventor: Daniel Fishkov, San Jose, CA (US)

(21) Appl. No.: 14/759,019

(22) PCT Filed: Jan. 3, 2013
(86) PCT No.: PCT/US13/20171

§ 371 Date: Jul. 2, 2015

(51) Int. Cl. G06F 12/02; G06F 12/10

(52) U.S. Cl. CPC G06F 12/0246; G06F 12/1081; G06F 2212/2532; G06F 2212/7208

(57) ABSTRACT

A system, method and computer program product for communications between computer devices, including a mobile device having a mobile application running thereon; a specialized memory device having a memory device application running thereon and further having one of a memory device processor and a memory device controller; and a bus for providing communication between the mobile device and the specialized memory device. An unmodified file system and/or driver for the specialized memory device is employed on the mobile device. The specialized memory device processor or the specialized memory device controller need not employ file system awareness.

### BACKGROUND OF THE INVENTION

1. Field of the Invention

The present invention generally relates to systems and methods for communications between devices, and more particularly to a method and system for mobile phones, tablets, personal computers systems, and the like, to communicate with processors, controllers, and the like, residing on memory cards, such as microSD cards, SD cards, MMC cards, and the like.

2. Discussion of the Background

In recent years, there have been developed systems and methods for communications between devices, such as phones, tablets, personal computers systems, and the like, and processors, controllers, and the like, residing on memory cards, such as microSD cards, SD cards, MMC, cards, and the like. However, such systems and methods typically involve modification of drivers, software, hardware, and the like.

### SUMMARY OF THE INVENTION

Therefore, there is a need for a method and system that address the above and other problems with systems and methods for communications between devices, such as phones, tablets, personal computers systems, and the like, and processors, controllers, and the like, residing on memory cards, such as microSD cards, SD cards, MMC cards, and the like. The above and other problems are addressed by the illustrative embodiments of the present invention by providing a method and system, including a communications channel provided between a host system (e.g., a mobile handset, a phone, a tablet, a personal computer system, etc.) and a device, such as a processor, a controller, and the like, on a memory card (e.g., microSD card, SD card, MMC card, etc.). The illustrative system and method does not require modification to an existing file system or the memory device driver that runs on the host system, as well avoiding a need to be file system aware on the device side. Standard files used as data FIFOs can be employed over the existing file system that runs on the host, and used as a gateway for the communication channels that run from host to the device, and without disabling standard file system accesses invoked by other users that share the same host system and employ standard file access for data is stored on the same device. A designated file for each such special communication channel can be created, wherein the file system allocates and associates specific block/sector addresses for such as file, and the device maps such block/sector addresses associated with the communication channel a memory thereof. Whenever the host accesses the designated file, the file system translates such access into block/sector level accesses to the device driver, which then issues access operations for such blocks to the actual device (e.g., microSD card, SD card, MMC card, etc.). The device matches the addresses of the blocks to the earlier created channels, and then routes the data to a consumer thread or process that runs on the device and that was associated with such particular communication channel, rather than handling such communications as standard mass storage operation and/or read/write data from/to flash memory. Such blocks are not necessarily written to the flash memory of the device, and requests with block addresses that do not match can be considered as standard mass storage requests that are served as normal file system operations (e.g., sector read/writes, etc.). Advantageously, other applications that run on the same host can use the file system for mass storage within the same device. The implementation of the file access level, for example, as used by a communication manager running on the handset, and the like, can employ multiple files to communicate with iSD. Accordingly, a file is opened for each communication manager and can be altered by usage of a single command used for all suitable communication channels, wherein the distinction between the various channels can be based on a location within the file that can be translated into distinct and unique block address accesses.

Accordingly, in an illustrative aspect, there is provided a system, method and computer program product for communications between computer devices, and which can include a mobile device having a mobile application running thereon; a specialized memory device having a memory device application running thereon and further having one of a memory device processor and a memory device controller; and a bus for providing communication between the mobile device and the specialized memory device. An unmodified file system and/or driver for the specialized memory device can be employed on the mobile device. The specialized memory device processor or the specialized memory device controller need not employ file system awareness.

The specialized memory device can be one of a Secure Digital (SD) memory device and a MultiMediaCard (MMC) memory device. The bus can be one of a SD bus, and a MMC bus, respectively.

A communication manager can be provided and can be configured to distinguish communications on the bus between a generic memory device and the mobile device, and communications on the bus between the specialized memory device and the mobile device.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative system, including a layered communication stack between mobile handset and a memory device;

FIGS. 2A-2E is an illustrative block diagram of handset communication to a processor inside a memory device and examples of typical communication requests;

FIGS. 3A-3B are an illustrative flow diagram for sending a buffer from mobile handset to a processor on an SD Card;

FIGS. 4A-4B are an illustrative flow diagram showing an initial communication between a host and a processor being established; and

FIGS. 5A-5B are an illustrative flow diagram showing opening of a communication channel between an application running on a host and an application running on an SD Card processor.

### DETAILED DESCRIPTION OF THE PREFERRED EMBODIMENTS

The present invention include recognition that systems and methods for communications between devices, such as phones, tablets, personal computers systems, and the like, and processors, controllers, and the like, residing on memory cards, such as microSD cards, SD cards, MMC cards, and the like, typically involve modification of drivers, software, hardware, and the like. Specifically, such functionality may involve modification of host drivers (e.g., Linux, Android, Windows, etc.) for sending special, non-standard commands to support the special communication channels between the host and the processor or modification of the host file system. However, such processes are not favorable and in most cases not accepted by many service providers, such a mobile network operators, and the like, as this requires low level system software and/or hardware modifications of the devices, such smartphones, and the like. The present invention further includes recognition that other approaches require file system structure awareness on the processor (e.g., device) side. Considering the wide variety of file systems, and the fact the new file systems are constantly added, such approach requires a lot of resources, and is not scalable, and the like.

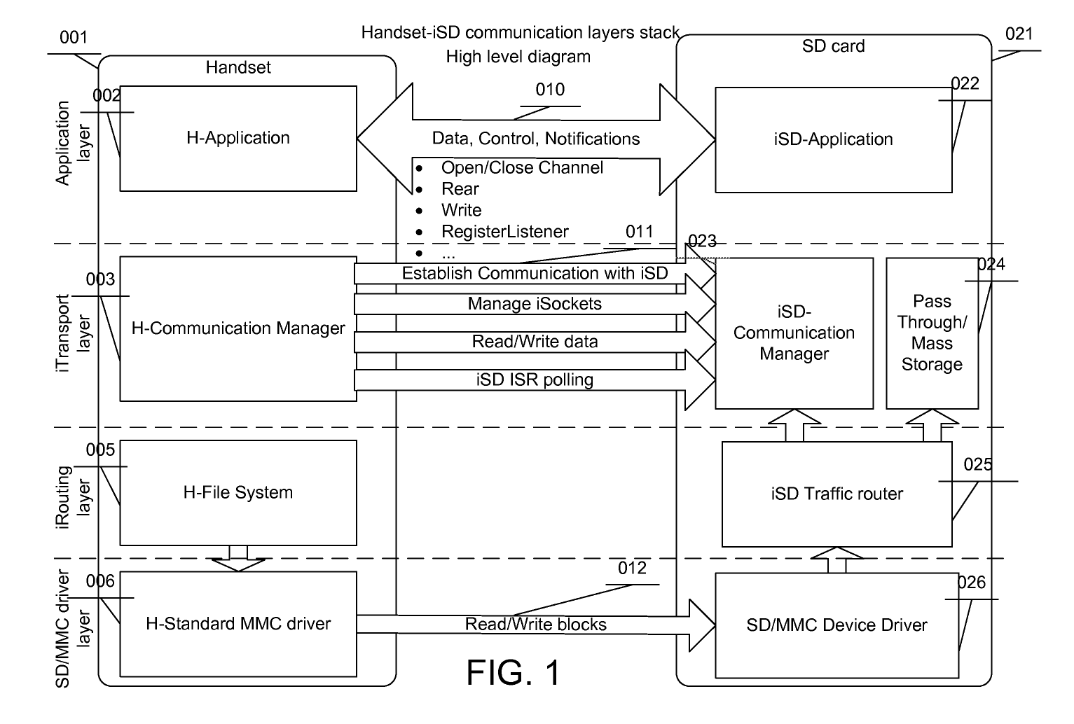

Referring now to the drawings, wherein like reference numerals designate identical or corresponding parts throughout the several views, and more particularly to FIG. 1 thereof, there is shown an illustrative system, including a layered communication stack between mobile handset and a memory device. In FIG. 1, the illustrative system provides a communication stack between a device (e.g., a phone, a tablet, a personal computer system, etc.), such as a mobile handset 001 or any other suitable host, with a processor (not shown) residing on a memory device (e.g., a microSD card, an SD car, an MMC card, etc.), such as an SD card 021. The processor, however, can reside on any other suitable device, according to further illustrative embodiments. The handset 001 allows seamless communication between H-Application 002 that runs on the host 001 and iSD-Application 022 that runs on the SD card 021.

The H-Application 002 has the ability to send and receive data 010 (e.g., data buffers, control messages, notifications, etc.) from the associated iSD-Application 022, for example, using any suitable abstract data, control transfer interfaces, and the like, that are convenient for a specific application. The communication channels are managed by communication managers, such as H-Communication Manager 003 that runs on the handset 001, and iSD-Communication Manager 023 that runs on the SD Card 021. The H-Communication manager 003 translates data/control transfer requests 010 into file accesses on a host file system, such as H-File System 005. The file system need not be limited to any specific type of file system, and can be provided along with the handset operating system, and/or the software framework.

The H-File System 005 can translate file level access into block level accesses with associated block addresses and can send the requests to a standard SD/MMC driver 006 provided by the operating system that runs on the handset 001. The SD/MMC driver 006 can send the requests 012 over an SD bus to a SD/MMC Device Driver 026 that runs on the SD Card 021. The SD Device Driver 026 can forward the request to an iSD Traffic router 025 that based on the block address associated with the request can make a decision on whether or not the request is a standard mass storage operation or a special communication channel request that is coming from the H-Communication Manager 003.

In the case of a standard mass storage operation, the request can be served in standard way that mass storage operations are served by a Pass Through/Mass Storage server 024. In the case of a communication from the H-Communication Manager 003, the request can be routed to the iSD-Communication Manger 023 for further data/control buffer handling. The iSD-Communication manager 023 can send/receive data buffers with the iSD-Application 022 associated with the specific communication channel. This closes the communication loop between the H-Application 002 that runs on the handset 001 and the associated iSD-Application 022 that runs on the SD Card 021.

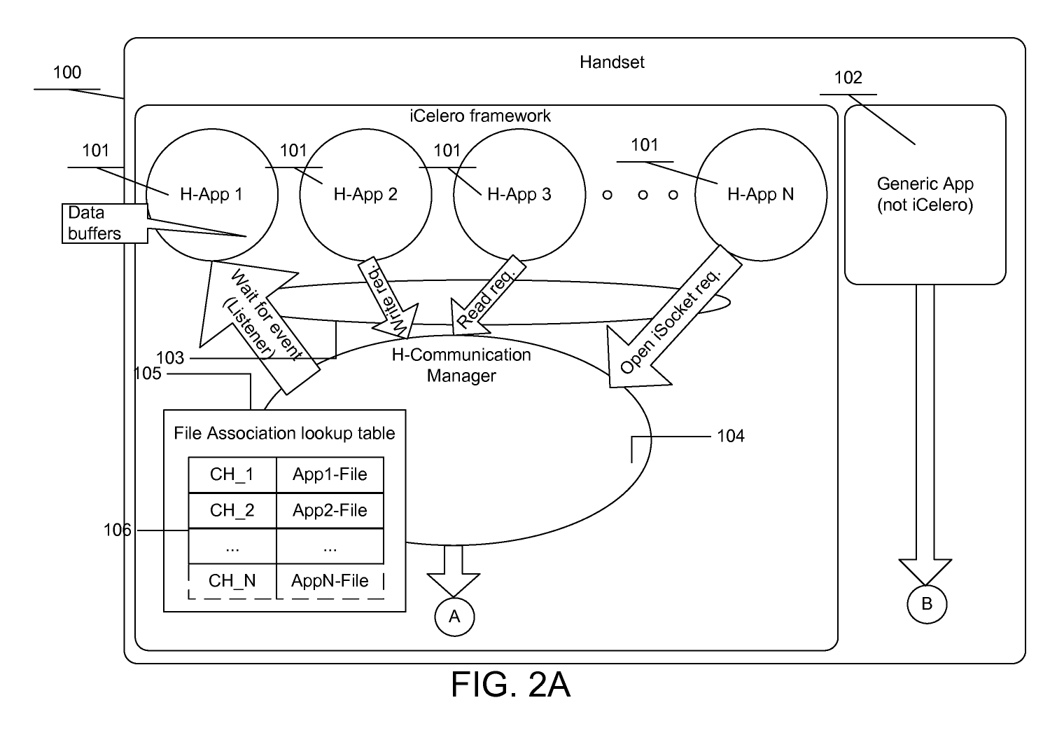

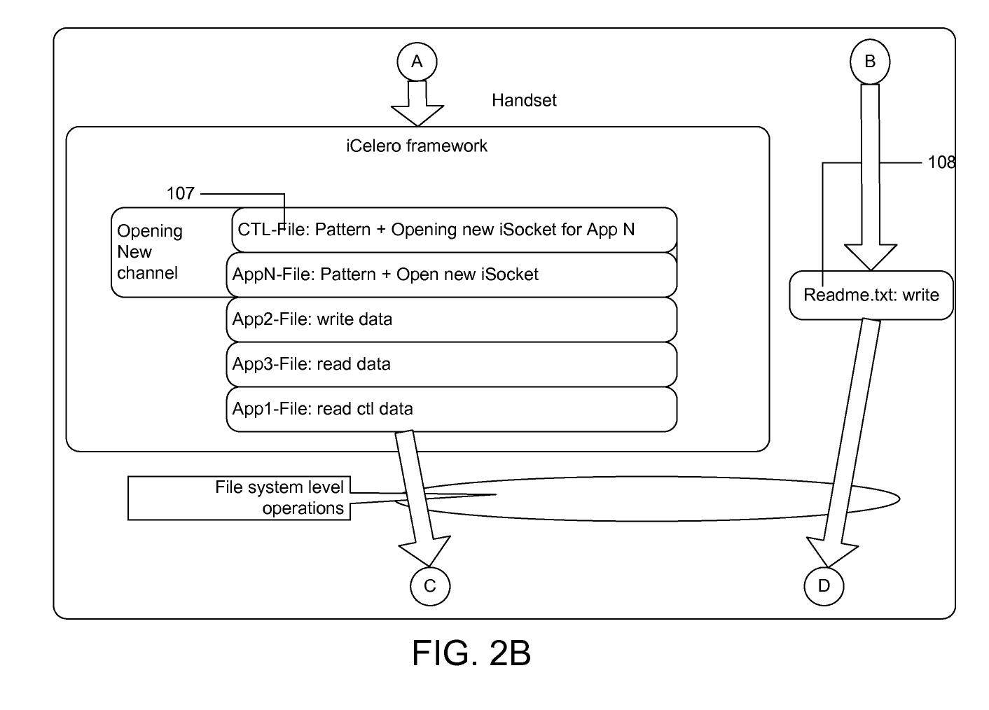

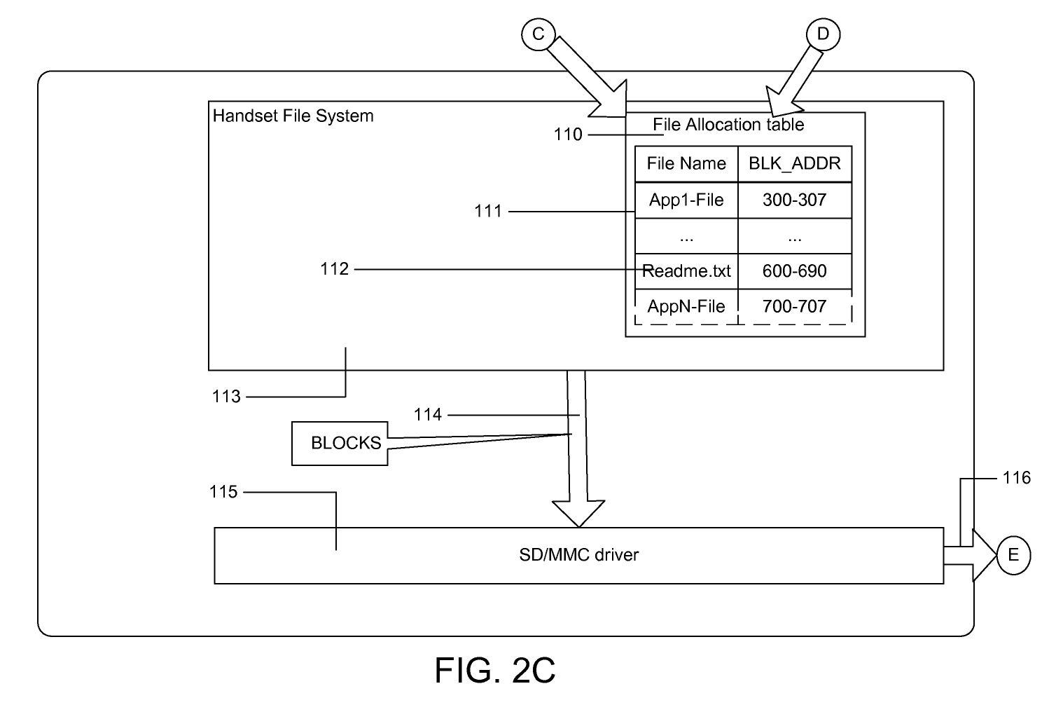

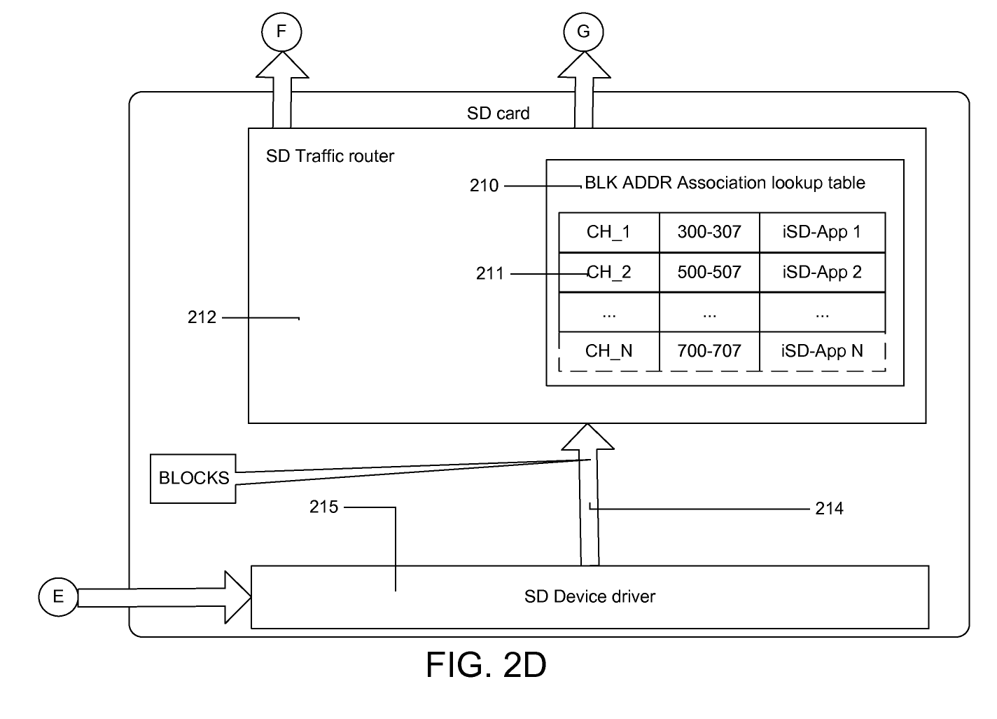

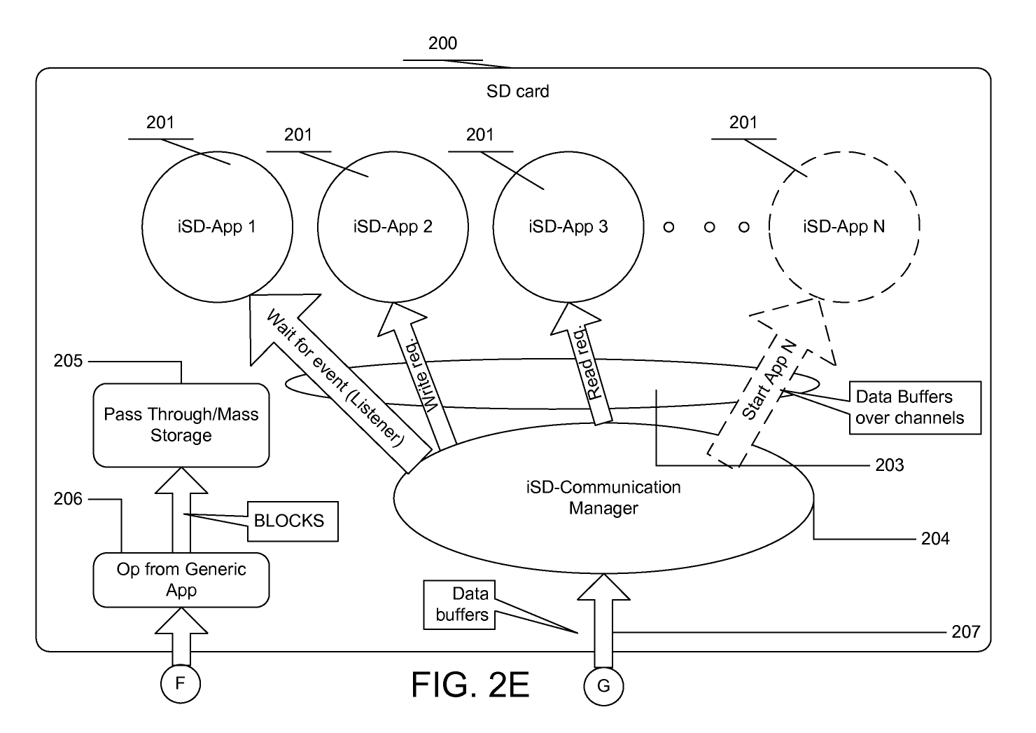

FIGS. 2A-2E is an illustrative block diagram of handset communication to a processor inside a memory device and examples of typical communication requests. In FIGS. 2A-2E are shown examples of data flows for multiple H-Applications 101 that run on a handset 100 communicating with iSD-Applications 201 that run on an SD card, along with generic application 102 that accesses the SD card via a file system for mass storage purposes. For example, an H-App X 101 that has opened a communication channel with its associated iSD-Application 201 that runs on SD Card sends/receives data/control buffers 103 via interface to H-Communication Manager 104.

The H-Communication Manager 104 finds a file name associated with the communication channel 106 in the File Association Lookup Table 105 and then translates FIFO-type requests 103 into file level operations 107. The requests are translated into appropriate file access to the top of the file. For example, a request to send a buffer to iSD-Application 201 can be translated into write request 107 to the top of the associated file, whereas a request for receiving the buffer can be translated into reading from the top of the associated file. The H-File System 113 can then find the block addresses associated with the file 111 in the File Allocation Table 110, and send block level requests 114 to the SD/MMC card driver 115 that sends the requests and data over the physical SD bus 116.

Advantageously, the processing described above does not interfere with any other file system operation 108 that may come from any generic operation 102 whose file system requests can be handled by the H-File System 113 in the same way as in the case of the special communication channel though by sending the generic request to block addresses associated with this specific file 112 served for storing data on SD Card 200.

All block level request 116 arrive to SD Device Driver 215 that runs on SD Card 200. The requests 214 are then transferred to SD Traffic Router 212. The SD Traffic Router 212 can try to find the block address associated with the request in BLK Address Association Lookup Table 210. If an entry 211 with the block address is found, then the SD Traffic Router 212 can send the data buffers/request 207 along with the associated CH_x number further to iSD-Communication Manager 204. In case such entry 211 is not found, in other words if the BLK Address is not found in the lookup table 210, then the operation is considered a generic mass storage operation 206 and can be routed to the Pass Through/Mass Storage Server 205. The iSD-Communication Manager 204 can then send/receive data/control buffers 203 from iSD-App 201 associated with the communication channel CH_x.

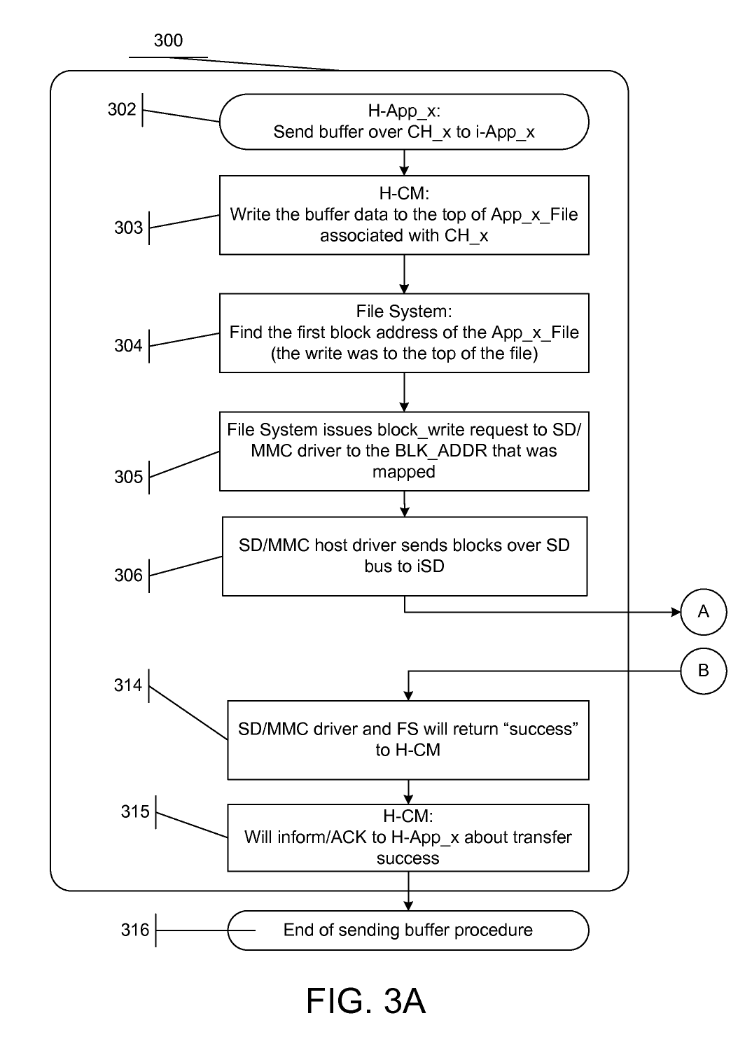

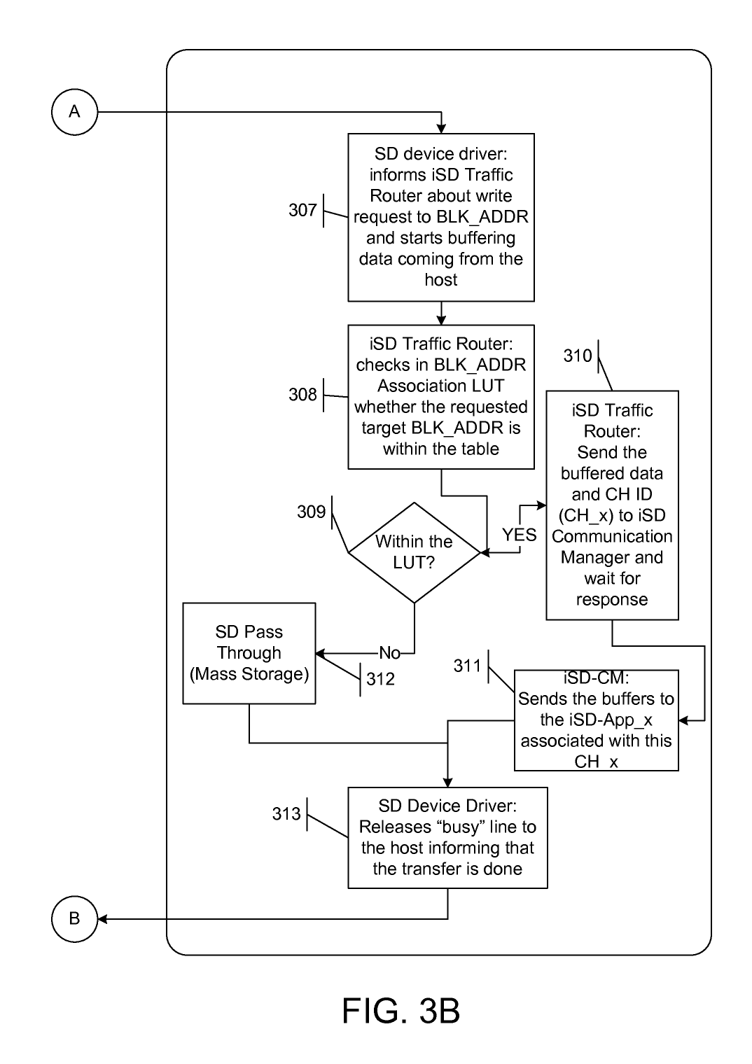

FIGS. 3A-3B are an illustrative flow diagram for sending a buffer from mobile handset to a processor on an SD Card. In FIGS. FIGS. 3A-3B, an example of sending a data buffer from an H-App that runs on a mobile handset 300 to an iSD-App that runs on SD Card 301 over SD/MMC data bus is shown. Accordingly, buffer send request step 302 is initiated by an H-App_x to an iSD-App_x over a communication channel CH_x. In step 303, an H-CM (H-Communication Manager) writes the data buffer to the top of the App_x_File file associated with the CH_x communication channel. In step 304, the File System finds the address of the first block of the App_x_File in the File Allocation Table, and in step 305 it issues write request to this BLK_ADDR to SD/MM driver. In step 306, the SD/MMC host driver issues a write command to BLK_ADDR on SD bus. The SD/MMC device driver receives the request in step 307, and informs the iSD Traffic Router about the request and associated BLK_ADDR.

In step 308, the iSD Traffic Router checks if the BLK_ADDR is within the BLK_ADDR Association look up table (LUT). If so, as determined by steps 309 and 310, the iSD Traffic Router sends the data, request and channel ID CH_x associated with the BLK_ADDR (e.g., extracted from the association table) further to the iSD-Communication Manager, which in step 311 sends the buffer to the iSD-App_x associated with the CH_x. If not, as determined by steps 309 and 312, the iSD Traffic Router sends the data and request to the Pass Through/Mass Storage server for generic mass storage operation.

At the end of either step 310 or 312, the SD Device Driver releases a busy line in step 313 indicating to the SD Host Driver that the operation is complete. The SD Host Driver then informs the file system (FS) in step 314 about the successful completion of the operation, which also returns a success status to the H-Communication Manager. The H-Communication Manager then returns a success/acknowledgment (ACK) in step 315 to the H-App_x, completing the processing at step 316.

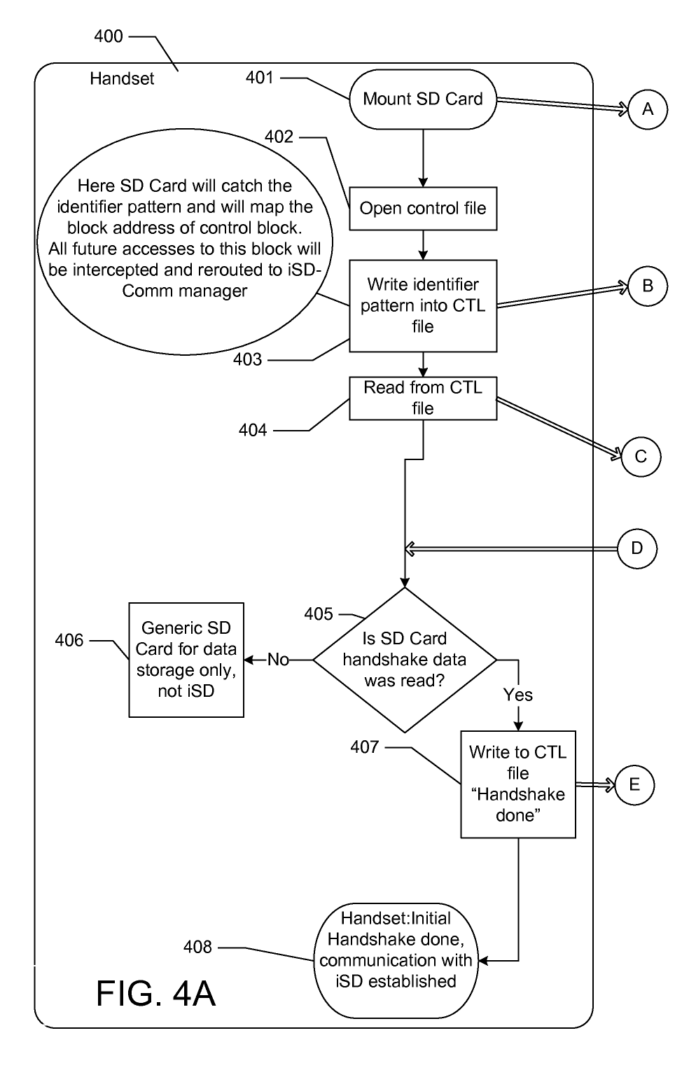

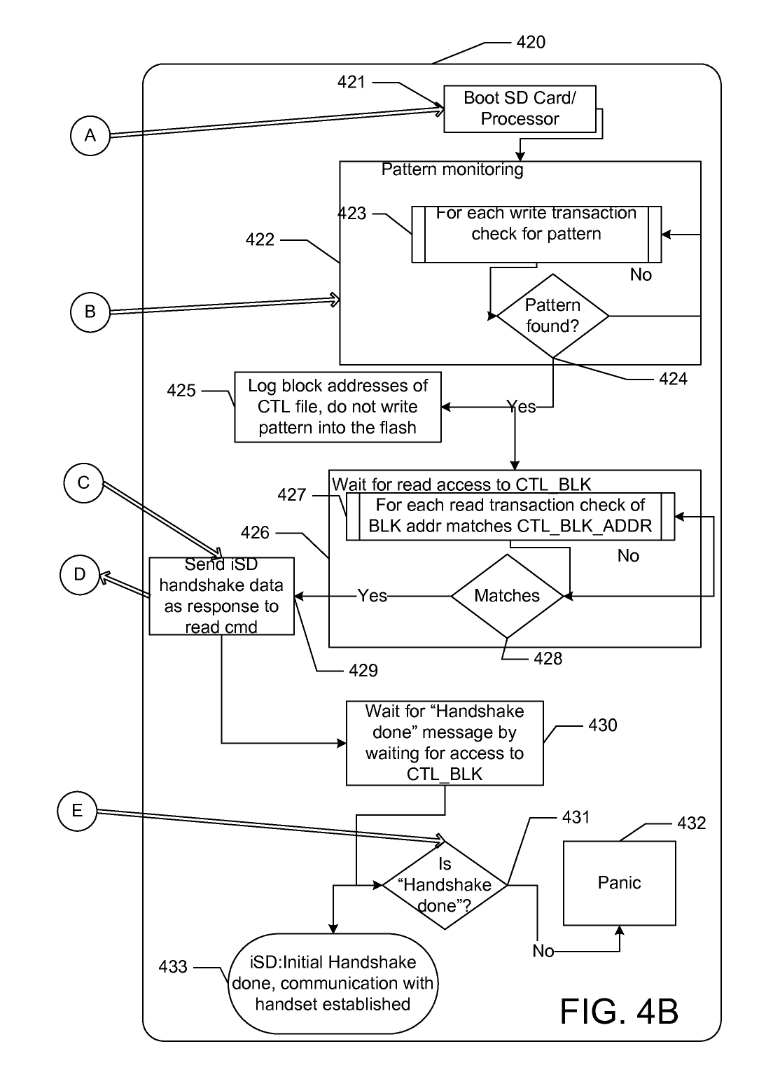

FIGS. 4A-4B are an illustrative flow diagram showing an initial communication between a host and a processor being established. In FIGS. 4A-4B, an example of how an initial communication is established between a handset and special purpose SD card is shown. For example, when the SD card is mounted, powered ON or initialized, a communication manager running on handset can establish an initial communication with the processor running on the SD Card. Accordingly, in step 421, when the SD card is being powered up or reset, the processor can boot up and then switch into a waiting mode where processor waits for a special communication from the handset to establish an initial communication channel at step 422. In step 422, the monitoring is done by waiting for a specific data pattern in write requests. For example, when a block is being written, the SD Card can check for specific data pattern, as in steps 423 and 424.

On the handset side, the communication manager can open a designated control file, as in step 402, and can write the predefined pattern into it. Such a write request can be caught by the SD Card in step 422 by spotting the specific pattern and then moving forward into establishing the communication in step 425. In step 425, the communication manager on the SD Card can log the block address(es) used by the write command with the initial pattern into the BLK ADDR association LUT, and then can move into the second phase of the handshake, where it can wait for a read request from the same block address, as in step 426. After writing into the control file, the host communication manager can try to read back from the control file, as in step 404, to make sure that the card is special purpose SD Card and the handshake has been started according to the protocol.

The SD Card communication manager can catch such a read in step 428, and can send data acknowledging initiation of the handshake in step 429, and then moves into step 430 to receive a confirmation from the handset informing that the initial communication between handset and the special purpose SD Card is being established. The read data can be tested in step 405 for matching the expected handshake data. In the case of no match of the expected handshake data, as in step 406, the communication manager can assume that the SD card is not a special purpose SD Card, but rather a generic data storage memory card. In the case of a match of the expected handshake data, as in step 407, the communication manager running on handset can send “handshake done” information to the processor running on the SD Card by writing the special data into the predefined location in the control file.

The SD Card communication manager then can intercept the write command in step 430, as it can be addressed to the block address within control file block address range, and can test the data in step 431 for the “handshake done” pattern. In the case of no match, as in step 432, then this is an unexpected result and can be handled in any suitable manner, including generating an error message, and the like. In the case of a match, then the handshake process is completed from the SD card point of view, as in step 43, and the card can switch into a block address monitoring mode. On the handset side, the communication manager can conclude the initial communication process in step 408.

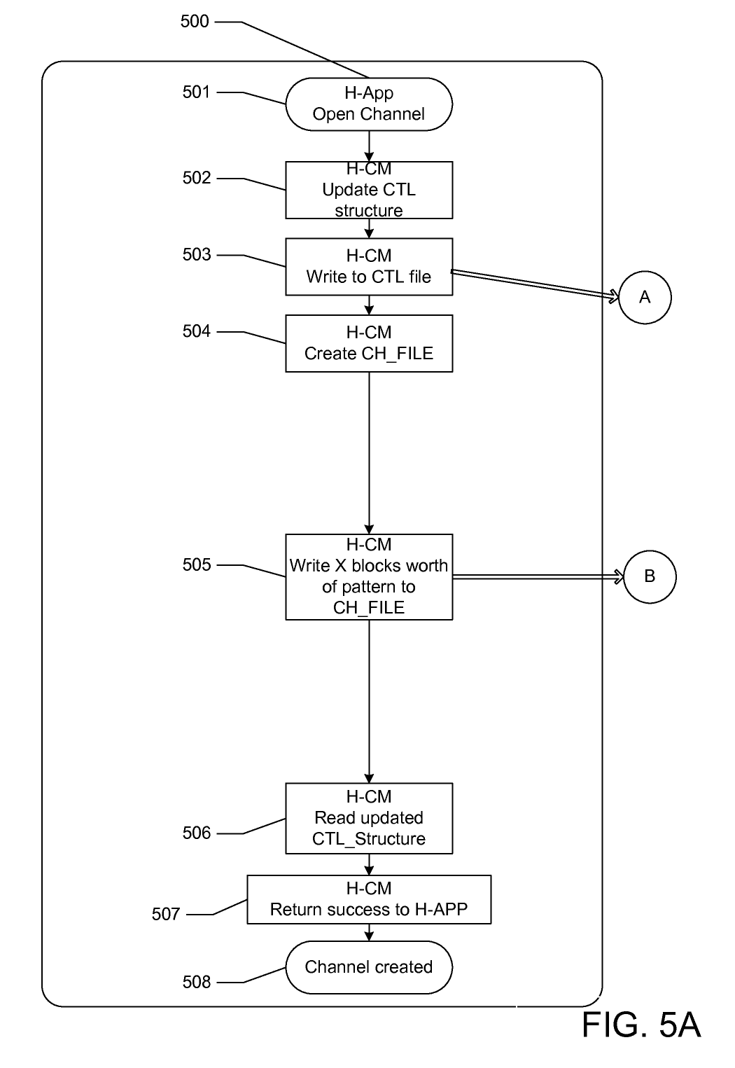

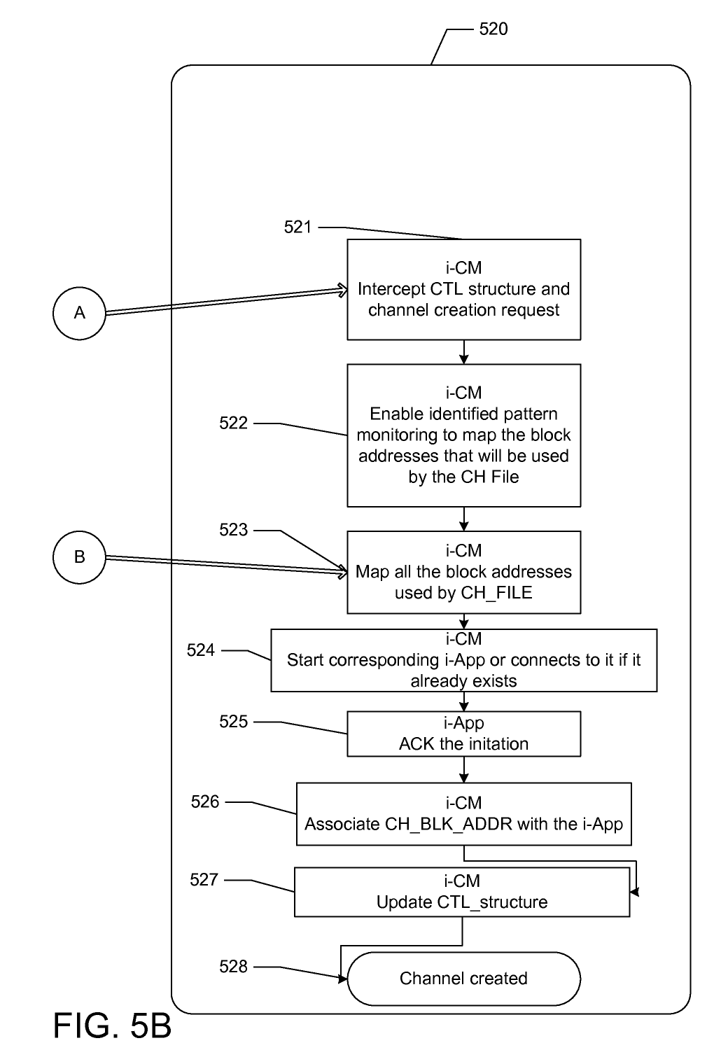

FIGS. 5A-5B are an illustrative flow diagram showing opening of a communication channel between an application running on a host and an application running on an SD Card processor. Accordingly, in FIGS. 5A-5B, a communication channel is being opened between an application running on a handset (H-App) and its associated application running on am SD Card (iSD-App). For example, when an H-App needs to open a new communication channel at step 501, the H-App can call a designated H-CM (handset communication manager) application programming interface (API) and specify an iSD-App identification (ID) that is going to be associated with such communication channel. The H-CM can create an entry in the association LUT that can link between the channel and the H-App, as in step 502, and then can inform an iSD-CM (communication manager running on SD Card) about the opening of the new communication channel. For example, this can be achieved by updating a control structure and writing it into a control file (CTL_FILE) in step 503. The iSD-CM can intercept the write request, as it is mapped into a block address range of the control file, as in step 521, and then can identify the block addresses that can be allocated by the host file system to the new channel/file, and hence can move into a data pattern monitoring stage, as in step 522.

The H-CM then can create a new file (CH_FILE) in step 504, and associate it with the newly created channel. The H-CM then can write a number of data blocks into the newly created file, where the data blocks can have a special predefine pattern that can mark the blocks as occupied by the CH_FILE, as in step 505. The iSD-CM can catch the write request to each block in step 523, as they can carry the predefined data pattern, and can associate the block addresses with the newly created channel and the iSD-App ID that can be connected to such communication channel.

The iSD-CM then can start the iSD-App associated with the newly created communication channel, if it is not already running, as in step 524. The iSD-App can acknowledge the initiation of the such communication in step 525, and the iSD-CM can finish the association by updating the BLK_Address association LUT and the master CTL structure, as in steps 526 and 527, concluding the channel creation process in step 528. The H-CM can determine successful completion of the new communication channel creation by reading back the CTL structure from the CTL_File, as in step 506, and returning according success status back to H-App, as in step 507. By such process, creation of a new communication channel is complete on the handset side, as in step 508.

The above-described devices and subsystems of the illustrative embodiments of FIGS. 1-5 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1-5. The devices and subsystems of the illustrative embodiments of FIGS. 1-5 can communicate with each other using any suitable protocol and can be implemented using one or more programmed computer systems or devices.

One or more interface mechanisms can be used with the illustrative embodiments of FIGS. 1-5, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1-5 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-5 can be implemented via one or more programmed computer systems or devices.

To implement such variations as well as other variations, a single computer system can be programmed to perform the special purpose functions of one or more of the devices and subsystems of the illustrative embodiments of FIGS. 1-5. On the other hand, two or more programmed computer systems or devices can be substituted for any one of the devices and subsystems of the illustrative embodiments of FIGS. 1-5. Accordingly, principles and advantages of distributed processing, such as redundancy, replication, and the like, also can be implemented, as desired, to increase the robustness and performance the devices and subsystems of the illustrative embodiments of FIGS. 1-5.

The devices and subsystems of the illustrative embodiments of FIGS. 1-5 can store information relating to various processes described herein. This information can be stored in one or more memories, such as a hard disk, optical disk, magneto-optical disk, RAM, and the like, of the devices and subsystems of the illustrative embodiments of FIGS. 1-5. One or more databases of the devices and subsystems of the illustrative embodiments of FIGS. 1-5 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-5 can include appropriate data structures for storing data collected and/or generated by the processes of the devices and subsystems of the illustrative embodiments of FIGS. 1-5 in one or more databases thereof.

All or a portion of the devices and subsystems of the illustrative embodiments of FIGS. 1-5 can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-5 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-5, for driving the devices and subsystems of the illustrative embodiments of FIGS. 1-5, for enabling the devices and subsystems of the illustrative embodiments of FIGS. 1-5 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-5. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-5 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for communications between computer devices, the system comprising:
a mobile device having a mobile application running thereon;
a specialized memory device having a memory device application running thereon and further having one of a memory device processor and a memory device controller; and
a bus for providing communication between the mobile device and the specialized memory device,
wherein an unmodified file system and/or driver for the specialized memory device is employed on the mobile device, and
the specialized memory device processor or the specialized memory device controller need not employ file system awareness.

2. The system of claim 1, wherein the specialized memory device is one of a Secure Digital (SD) memory device and a MultiMediaCard (MMC) memory device, and
the bus is one of a SD bus, and a MMC bus, respectively.

3. The system of claim 1, further comprising:
a communication manager configured to distinguish communications on the bus between a generic memory device and the mobile device, and communications on the bus between the specialized memory device and the mobile device.

4. A computer implemented method for communications between computer devices, the method comprising:
providing a mobile device having a mobile application running thereon;
providing a specialized memory device having a memory device application running thereon and further having one of a memory device processor and a memory device controller;
providing via a bus communication between the mobile device and the specialized memory device; and
employing on the mobile device an unmodified file system and/or driver for the specialized memory device; and
the specialized memory device processor or the specialized memory device controller not employing file system awareness.

5. The method of claim 4, wherein the specialized memory device is one of a Secure Digital (SD) memory device and a MultiMediaCard (MMC) memory device, and
the bus is one of a SD bus, and a MMC bus, respectively.

6. The method of claim 4, further comprising:
distinguishing with a communication manager communications on the bus between a generic memory device and the mobile device, and communications on the bus between the specialized memory device and the mobile device.

7. A computer program product for communications between computer devices and including one or more computer readable instructions embedded on a non-transitory, tangible computer readable medium and configured to cause one or more computer processors to perform the steps of:
providing a mobile device having a mobile application running thereon;
providing a specialized memory device having a memory device application running thereon and further having one of a memory device processor and a memory device controller;
providing via a bus communication between the mobile device and the specialized memory device; and
employing on the mobile device an unmodified file system and/or driver for the specialized memory device; and
the specialized memory device processor or the specialized memory device controller not employing file system awareness.

8. The computer program product of claim 7, wherein the specialized memory device is one of a Secure Digital (SD) memory device and a MultiMediaCard (MMC) memory device, and
the bus is one of a SD bus, and a MMC bus, respectively.

9. The computer program product of claim 7, further comprising:
distinguishing with a communication manager communications on the bus between a generic memory device and the mobile device, and communications on the bus between the specialized memory device and the mobile device.
